(19) United States
(12) Patent Application Publication
(10) Pub. No.: US 2011/0144874 A1
(43) Pub. Date: Jun. 16, 2011

(54) COMBINED BRAKE AND CLUTCH UNIT, COMBINED BRAKE AND CLUTCH UNIT WITH A YAW BRAKE AND METHOD FOR OPERATION THEREOF

(75) Inventors: Eckhard KIRCHNER, Ginsheim (DE); Mikael WESTERBERG, Vaenersborg (SE)

(73) Assignee: GM GLOBAL TECHNOLOGY OPERATIONS, INC., Detroit, MI (US)

(21) Appl. No.: 12/907,527

(22) Filed: Oct. 19, 2010

(30) Foreign Application Priority Data
Oct. 19, 2009 (GB) 0918279.1

(51) Int. Cl. F16D 48/06; F16D 13/00; F16H 3/44

(52) U.S. Cl. 701/67; 192/30 R; 475/269; 475/317

(57) ABSTRACT

A combined brake and clutch unit is provided for a drivetrain of a vehicle, such as a road vehicle, and a method is provided for operating the same. A brake ring is provided at a housing of a clutch which is enclosed by a brake actuator. The housing of the clutch is connected to a wheel axis and a clutch surface is connected to an axis of a vehicle. Furthermore, a multiplate clutch is provided for use as an interaxle differential.

### CROSS-REFERENCE TO RELATED APPLICATION

This application claims priority to British Patent Application No. 0918279.1, filed Oct. 19, 2009, which is incorporated herein by reference in its entirety.

### TECHNICAL FIELD

The technical field relates to brake and clutch unites, and more particularly to a combined brake and clutch unit.

### BACKGROUND

For the deceleration of a car's wheel, disk brakes and drum brakes are in current use. In the past, disk brakes have been used for the front wheels and drum brakes for the rear wheels, but nowadays disk brakes are used more often. Brakes may be regarded as a special type of clutch for coupling a movable part to a non-movable part. Commonly, for coupling and decoupling a gearbox, a drivetrain and wheels to the motor of the car, between the motor and a gearbox a launch clutch is provided for manual transmissions and a torque converter is provided for automatic transmissions. The clutch is used to launch the vehicle and to enable switching between different gears. Different gears are especially necessary for a combustion engine which can only work efficiently within a certain revolution speed range that is higher than the revolution speed of the wheels. Apart from providing a speed reduction, the gearbox also increases the torque of the engine. There exist also cars without a launch clutch, for example cars with a continuously variable transmission or with an electric motor, which provides a greater elasticity. The current application does not, however, apply to double clutch transmissions.

Besides the gearbox, there are further gears in common use to transmit the motor torque to the wheels such as bevel gears, differentials and other planetary gearsets. The use of computer technology permits the substitution of purely mechanical parts by mechatronic parts and adds additional security functions such as ABS, ESP, active steering and the like.

In particular, the handling and the safety of a car may be enhanced by analyzing the vehicle dynamics and modifying a torque distribution to the wheels in accordance with the vehicle dynamics. Thereby, oversteering and understeering situations may be avoided or at least minimized. Corresponding products have been introduced into the market under the name ‘active yaw’ or ‘torque vectoring’ systems. In a four wheel drive it is possible to reduce the undesired yawing by modifying a torque distribution between the front and rear wheels by using a controllable clutch. For example, Haldex® clutches, controllable viscous couplings and electromagnetic multiple disk clutches have been used for this purpose.

In front wheel or rear wheel driven cars it is necessary to provide a means of active lateral torque distribution to achieve an active yaw control, for example by using controlled overriding drives. One example of a controlled overriding drive which has been used extensively in tracked vehicles is the Cletrac® (Cleveland tractor) system which employs a spur differential which is nested within a bevel differential and wherein the output axes of the outer differential are connected to yaw brakes. A further development uses two stage incomplete planetary gears wherein the sun gear of the first stage is connected to a differential casing and the sun gear of the second stage is connected to a wheel axis to provide an alternative torque path. The carriers of the planetary gears are connected to yaw brakes. Furthermore, there are otherwise similar but asymmetric solutions with a multi stage planetary gear on one side only.

Yet a further development uses a spur gear on one side of a differential. A first gear of the spur gear is driven by the rotation of a differential case of a differential. Gears with different sizes which are on the same axis as the first gear drive hollow shafts that enclose a wheel axis. The rotation of the hollow shafts can be coupled to the wheel axis via controllable clutches which have a casing that is fixed to the wheel axis and which can be engaged to a variable degree.

It is also known to achieve a lateral torque distribution by providing a controlled clutch at the left and the right driven wheel. This solution makes it possible to avoid a standard differential altogether and is also capable to emulate a differential lock. Furthermore, it is known to achieve an active yaw control by using a controlled actuation of the car brakes or by providing additional brakes at the driven wheels, such as electromagnetic brakes which may also be used for energy recuperation.

In view of the foregoing, it is at least one object of the application to provide a combined brake and clutch unit for use in an improved drivetrain and it is at least a further object of the application to provide a combined brake and clutch unit for use in an improved active yaw control. In addition, other objects, desirable features and characteristics will become apparent from the subsequent summary and detailed description, and the appended claims, taken in conjunction with the accompanying drawings and this background.

### SUMMARY

More specifically, the present application discloses a combined brake and clutch unit for a drivetrain of a road vehicle. A brake ring is provided at a housing of a clutch. For example, the brake ring is formed as part of the clutch housing or it is a separate part which is attached to the clutch housing. A brake actuator, such as a caliper or a drum brake, exhibits a braking force on the brake ring. The housing of the clutch is connected to a wheel axis of a car and a clutch surface is connected to an axis of a vehicle. The clutch surface is, for example, designed as plate or ring or as a stack of interconnected plates or rings.

In a further embodiment, the combined brake and clutch unit comprises an incomplete planetary gearset. In yet a further embodiment, the combined brake and clutch unit comprises a complete planetary gearset and the clutch surface is formed as a clutch ring which is provided at a ring gear of the complete planetary gearset. In yet a further embodiment, the combined brake and clutch unit comprises a complete planetary gearset and furthermore a brake ring of a yaw brake is provided at a ring gear of the complete planetary gearset.

The application further discloses an arrangement of two or more combined brake and clutch units. In the arrangement, clutch actuators of the clutches of the combined brake and clutch units of the arrangement are connected to an electronic control unit. The connection may also be indirect in the sense that a hydraulic actuator which is connected to the clutch by a hydraulic line is connected to the electronic control unit. Furthermore, an arrangement of brake and clutch units is disclosed in which brake actuators of the yaw brakes of the arrangement are connected to the electronic control unit.

Furthermore, a multiplate clutch of a road vehicle is disclosed which is specially reinforced for use as an interaxle differential and also as launch clutch for the rear wheels of the road vehicle. For example, the clutch disks can be made of a durable ceramic material. Preferentially, the disclosed multiplate clutch is part of a drivetrain for a four wheel drive vehicle. In order to permit a variable transmission ratio between the front and the rear wheels it is advantageous to realize the multiplate clutch as a torque sensitive clutch. It is especially advantageous to use a multiplate clutch according to the application in connection with brake and clutch units at the front wheels of a four wheel drive car. Thereby, a launch clutch of a four wheel drive can be avoided.

The application also discloses a method for operating an arrangement of at least two combined brake and clutch units of a road vehicle according to the application. The methods comprises steps of measuring a torque at each of two wheels of the road vehicle of calculating degrees of engagement of the clutches of the combined brake and clutch unit with an electronic control unit such that the torque at the wheels is essentially equal and of applying clutch actuators of the combined brake and clutch units according to the calculated degrees of engagement. The calculation derives a reference value for the degree of engagement from a force reference value. The degree of engagement may be derived from the force reference value for example by using a lookup table, a physical model and/or input values from sensors.

The application furthermore discloses a method for operating an arrangement of at least two combined brake and clutch units with yaw brakes. Therein, a motion of the road vehicle is derived from sensor data and for each of the yaw brakes a reference value for the engagement of the yaw brakes is computed. According to the reference value of engagement the brake actuators of the yaw brakes are actuated.

### BRIEF DESCRIPTION OF THE DRAWINGS

The present invention will hereinafter be described in conjunction with the following drawing figures, wherein like numerals denote like elements, and

FIG. 1 illustrates a vehicle with two combined brake and clutch units at the front;

FIG. 2 illustrates a first combined brake and clutch unit;

FIG. 3 illustrates a second combined brake and clutch unit having an incomplete planetary gearset;

FIG. 4 illustrates a third combined brake and clutch unit with a complete planetary gearset;

FIG. 5 illustrates a fourth combined brake and clutch unit with a planetary gearset and yaw brake;

FIG. 6 illustrates a four wheel drive vehicle with combined brake and clutch units at the front;

FIG. 7 illustrates a four wheel drive vehicle with combined brake and clutch units at the front and combined brake and clutch units with planetary gearset at the back;

FIG. 8 illustrates a four wheel drive with combined brake and clutch units at the front and at the back;

FIG. 9 illustrates a four wheel drive with combined brake and clutch units at the front and at the back and with a torsen clutch at the front;

FIG. 10 illustrates a multiplate wet-type clutch for use in a combined brake and clutch unit;

FIG. 11 illustrates a torque flow for a configuration that replaces a differential; and

FIG. 12 illustrates the relative engagement of a clutch and a yaw brake.

### DETAILED DESCRIPTION

The following detailed description is merely exemplary in nature and is not intended to limit application and uses. Furthermore, there is no intention to be bound by any theory presented in the preceding background or summary or the following detailed description. Moreover, in the following description, details are provided to describe the embodiments of the application. It shall be apparent to one skilled in the art, however, that the embodiments may be practiced without such details. For example, specific front and four wheel drive arrangements are shown, although combined brake and clutch units according to the application may be used with different types of arrangements and also with arrangements including rear wheel drives.

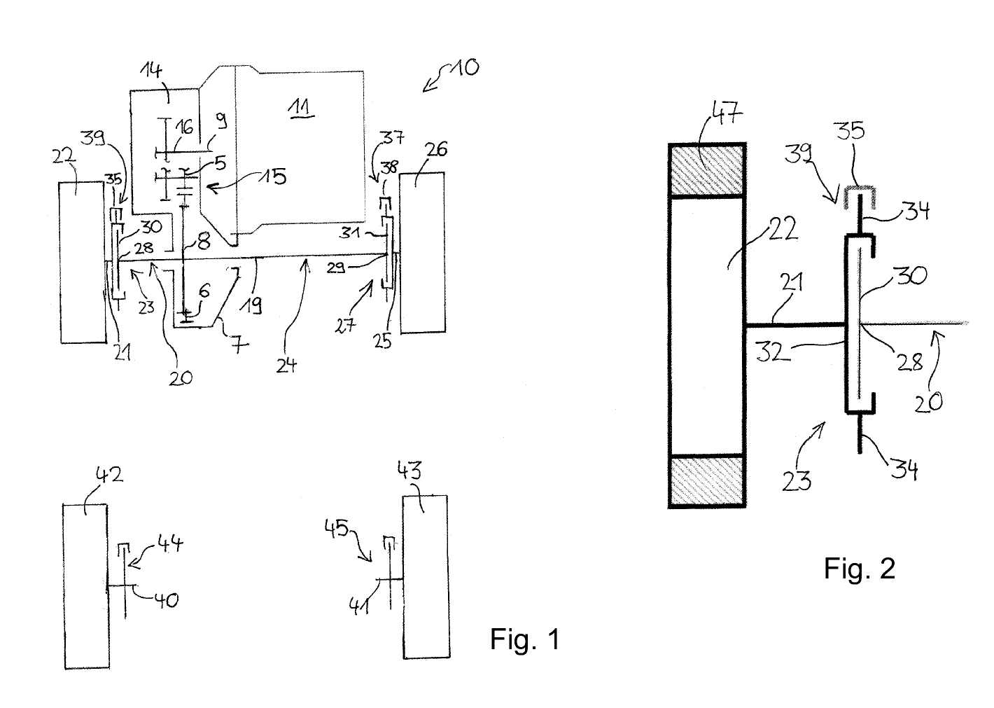

FIG. 1 shows a vehicle 10. A combustion engine 11 is transversely-mounted in an engine bay of vehicle 10. A crankshaft 9 of the combustion engine 11 is connected to a front gearwheel 8 via a transmission 14 and connecting gearwheels 15. The front gearwheel 8 is provided on the front axis 19 and is meshing with one of the connecting gearwheels 15. The crankshaft 9 is in a permanent connection with an input shaft 16 of the transmission 14, such that the gearwheels of the transmission 14, the connecting gearwheels 15, the front gearwheel 8 and the front axis 19 are rotating with the crankshaft 9 when a gear of the transmission 14 is engaged. For reasons of simplicity, the transmission 14 and the connecting gearwheels 15 are only indicated schematically.

For automatic transmissions, the input shaft is accordingly connected to the engine crankshaft and not to the turbine shaft of the conventional torque converter. The connecting gearwheels comprise an output pinion 5 which is arranged on a layshaft of the transmission and a ring gear 6. The ring gear 6 is meshing with the front gearwheel 8. In the embodiment of FIG. 1, the output pinion and the ring gear 6 constitute the final drive of the transmission. Alternating embodiments which use for example a belt drive and a planetary differential are equally possible.

A left axle shaft 20 of the front axis 19 is connected to a wheel shaft 21 of a left front wheel 22 via a left combined brake and clutch unit 23 and a right axle shaft 24 of the front axis 19 is connected to a wheel shaft 25 of a right front wheel 26 via a right combined brake and clutch unit 27. A left end 28 and a right end 29 of the front axis 19 are connected to left and right clutch disks 30, 31 of the left combined brake and clutch unit 23 and the right combined brake and clutch unit 27, respectively. At the inner sides of the combined brake and clutch units 23, 27 and on the outer sides of the gear casing 7, constant velocity (CV) joints connect different sections of the front axis 19. These CV joints are not shown, for simplicity.

The wheel shafts 21, 25 comprise wheel hubs at their outer ends, which are not shown. End plates are provided at the outer ends of the wheel hubs for fixing the wheels 22, 26 to the wheel hubs via screw connections. The inner ends of the wheel shafts 21, 25 are each connected to a housing 32, 33 of the respective combined brake and clutch unit 23, 27. A left brake ring 34 of a left disk brake 39 is formed as a part of the clutch housing of the left combined brake and clutch unit 23. A left brake caliper 35 encloses the left brake ring 34. Likewise, a right brake ring 36 of a right disk brake 37 is formed as a part of the clutch housing 33 of the right combined brake and clutch unit 27 and a right brake caliper 38 encloses the right brake ring 36.

Shafts 40, 41 of a left rear wheel 42 and a right rear wheel 43 are connected to rear left and rear right disk brakes 44, 45 in a known way.

Left and right torque sensing means are provided close to the left and right front wheels 22, 26, respectively. The torque sensing means are connected to an electronic control unit (ECU). Outputs of the ECU are connected to clutch actuators of the combined brake and clutch units 23, 27, respectively. The ECU evaluates vehicle motion data and controls the clutches of the combined brake and clutch units 23, 27, such that they provide the function of a front transverse differential.

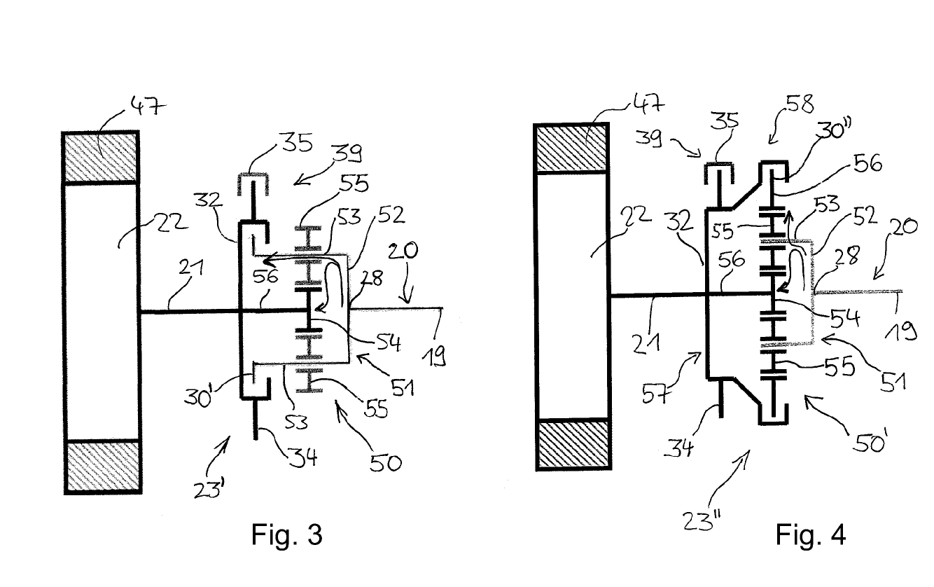

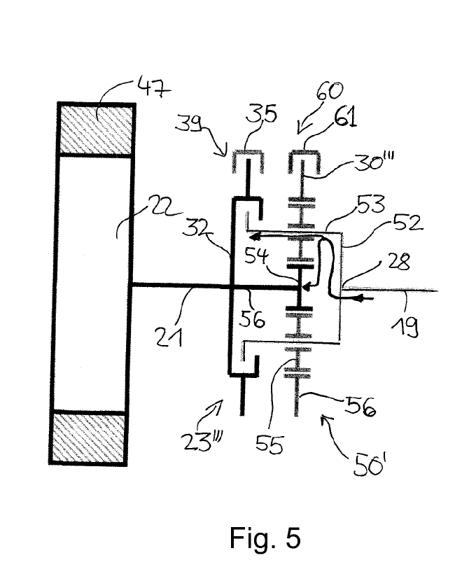

FIG. 2 to FIG. 5 show a combined brake and clutch unit in which a clutch housing of the combined brake and clutch unit is fixed to a wheel shaft of a wheel. A brake ring is formed as part of the clutch housing and is enclosed by a brake caliper. One or more friction surfaces are enclosed by the clutch housing. The friction surfaces, which are also known as clutch surfaces, are connected to an axis of a vehicle such that the friction surfaces rotate with a predetermined velocity ratio relative to the axis of the vehicle. The FIGS. 3 to 5 comprise a planetary gearset which reduces the torque to be transferred at the clutch of the combined brake and clutch unit. FIG. 5 shows a combined brake and clutch unit with a yaw brake.

FIG. 2 shows an enlarged section of FIG. 1, comprising the left front wheel 22 and the left combined brake and clutch unit 23. A tire 47 of the left front wheel 22 is shown with a shaded background. The function of the combined brake and clutch unit 23 is now explained with respect to FIG. 1 and FIG. 2. When axle shaft 20 is driven, the clutch of the combined brake and clutch unit 23 is engaged and the disk brake 35 is disengaged and a torque of the engine 11 is transmitted via the clutch housing 32 to the wheel shaft 21. When the disk brake 35 is actuated and the clutch of the combined brake and clutch unit 23 is engaged, a brake torque is transmitted from the disk brake 35 to the wheel shaft 21 via the clutch housing 32. A motor brake torque is transmitted to the wheel shaft 21 via the clutch and the clutch housing 32 as long as the axle shaft 20 is slower than the wheel shaft 21. When the disk brake 35 is actuated and the clutch of the combined brake and clutch unit 23 is disengaged, a brake torque is transmitted from the disk brake 35 to the wheel shaft 21 via the clutch housing 32. No motor brake torque is transmitted to the wheel shaft 21.

FIG. 3 shows a second embodiment of a combined brake and clutch unit through the example of a left combined brake and clutch unit 23′. Similar parts have the same or primed reference numbers. In contrast to the combined brake and clutch unit 23 of FIG. 2, the combined brake and clutch unit 23′ of FIG. 3 comprises a planetary gearset 50 without ring gear which is also referred to as incomplete planetary gearset, whereas a planetary gearset which also comprises an outer ring gear is referred to as complete planetary gearset. The end 28 of the front axis 19 is connected to a planet carrier 51 of the incomplete planetary gearset 50. The planet carrier comprises a disk 52, several planet axes 53 and a coupling ring 30′ which is provided at an outer end of the planet axes 53. The incomplete planetary gearset comprises a sun gear 54 and several planet gears 55. The sun gear 54 is fixed to a sun gear axis section 56 of the wheel shaft 21 of the left front wheel 22. The sun gear axis section is the section of the wheel shaft 21 which is located between the clutch housing 32 of the left combined brake and clutch unit and the sun gear 54. The planet gears 55 are mounted on the planet axes 53 such that they can freely rotate around the planet axes 53. The function of the combined brake and clutch unit 23′ during driving and braking will now be explained with reference to FIG. 3. The same considerations hold for the combined brake and clutch unit 23′″ of FIG. 5 when the yaw brake is open.

When the front axis 19 is driven and the clutch of the combined brake and clutch unit 23′ is fully engaged, the sun gear rotates rigidly with the planet gears around the wheel shaft 21. A torque from the engine 11 is transmitted via the planet carrier 51 and the clutch housing 32 to the wheel shaft 21. When the front axis 19 is driven and the clutch of the combined brake and clutch unit 23′ is disengaged, the planet gears roll off on the sun gear with a rotation velocity which is the difference of the rotation velocities of the front axis and the wheel shaft. If the rotation velocities of the front axis 19 and the wheel shaft 21 are not the same, a residual torque is still transmitted to the wheel shaft via the sun gear axis. When the front axis 19 is driven and the clutch of the combined brake and clutch unit 23′ is partially engaged, a torque from the engine 11 is distributed between the planet axes 53 and sun gear axis through a first and a second torque path. In FIG. 3, the first and second torque path are indicated by arrows. The amount of torque transmitted through the sun gear depends on the inertia of the planet gears and the friction of the planet gears on the planet axis. When, during a braking process, the disk brake 39 is actuated and the combined brake and clutch unit is fully engaged, a brake torque is transmitted from the disk brake via the clutch housing 32 to the wheel shaft 21. As long as the disk brake 39 is sliding and the axle shaft 20 is slower than the wheel shaft 21, a motor brake torque is transmitted to the wheel shaft 21 via the planet carrier 51 and the clutch housing 32. When the disk brake is actuated and the combined brake and clutch unit is disengaged, a brake torque is transmitted to the wheel shaft via the clutch housing 32. Additionally, a residual motor brake torque is transmitted via the planet gears 55 and the sun gear 54. When the disk brake 39 is actuated and the combined brake and clutch unit is partially engaged, a first fraction of the braking torque from the brake caliper of the disk brake 35 is transmitted via the clutch housing 32. As long as the disk brake 39 is sliding and the axle shaft 20 is slower than the wheel shaft 21, a motor brake torque is transmitted to the wheel shaft 21 via the planet carrier 51 and the clutch housing and also via the planet gears 55 and the sun gear 54.

FIG. 4 shows a third embodiment of a combined brake and clutch unit through the example of a left combined brake and clutch unit 23″. Parts which are similar to FIG. 3 have the same or primed reference numbers as compared to FIG. 3. Parts which differ from FIG. 3 are explained below. The embodiment of FIG. 4 comprises a complete planetary gearset 50′. The end 28 of the front axis 19 is fixed to a planet carrier 51 of the complete planetary gearset 50′. Planet gears 55 are mounted on planet axes 53 such that they are freely rotatable around the planet axes 53. The planet axes are not fixed to a coupling ring 30′ as in FIG. 3. Instead, in FIG. 4, an coupling ring 30″ of a ring gear 56 of the planetary gearset 50′ is formed as a clutch ring. The clutch housing 32 of the combined brake and clutch unit comprises an outer part 57 and an inner part 58, which are each concentric to the wheel shaft 21. The outer part has a smaller diameter than the inner part. A left brake ring 34 is fixed to the outside of the inner part 58. The outer part 57 encloses the complete planetary gearset 50′ and is in mechanical contact with the coupling ring 30″ when the combined brake and clutch unit 23″ is engaged. The function of the combined brake and clutch unit 23″ during driving and braking will now be explained with reference to FIG. 4.

When the front axis 19 is driven and the clutch of the combined brake and clutch unit 23″ is fully engaged, the complete planetary gearset 50′ rotates rigidly with the clutch housing 32. The torque rests on the teeth of the sun gear 54 and the teeth of the ring gear 56, which are locked against each other. Different from the embodiment of FIG. 3 the torque flow is evenly distributed between the sun gear 54 and the clutch housing 32. When the clutch of the brake and clutch unit 23″ is only partially engaged, the torque flow to the wheel shaft 21 is reduced and a smaller proportion of the torque flow is transmitted via the clutch housing 32. When the clutch is completely disengaged, only a residual torque flow is transmitted via the sun gear 54 which results from the planet gears 55 rolling off on the sun gear 54, and no torque flow is transmitted via the clutch housing 32. When, during a braking process, the disk brake 39 is actuated and the clutch of the combined brake and clutch unit is fully engaged, a brake torque is transmitted from the disk brake via the clutch housing 32 to the wheel shaft 21. As long as the disk brake 39 is sliding and the axle shaft 20 is slower than the wheel shaft 21, an additional motor brake torque is transmitted to the wheel shaft 21. The torque flow of the motor brake torque is the same as the previously explained torque flow from engine 11, only the direction of the torque is reversed.

FIG. 5 shows a fourth embodiment of a combined brake and clutch unit through the example of a left combined brake and clutch unit 23″. Parts which are similar to FIG. 3 or 4 have the same or primed reference numbers. The embodiment of FIG. 5 is similar to the embodiment of FIG. 3 but comprises in addition an electronically controlled yaw brake 60 with a brake caliper 61 which acts on a coupling ring 30′″ of a complete planetary gearset 50′. The coupling ring 30′″ of FIG. 5 is formed as a part of the ring gear 56 of the complete planetary gearset 50′ of FIG. 5 in a similar way as the coupling ring 30″ of FIG. 4 is formed as a part of the ring gear 56 of FIG. 4.

An output of a left torque sensing means for sensing the torque at the left wheel 22 is provided at a location between the wheel and the brake caliper. The output of the left torque sensing means is connected to an electronic control unit. Similarly, the output of a right torque sensing means for sensing a torque at the right wheel 26 is connected to the electronic control unit. A control output of the electronic control unit is connected to the electronically controlled yaw brake 60. Other parts of FIG. 5 are similar to the embodiment of FIG. 3. As the function of the disk brake and the clutch of the combined brake and clutch unit 23′″ is similar to FIG. 3, and only the function of the yaw brake 61 will be explained in the following.

When the yaw brake 60 is fully engaged and the clutch of the combined brake and clutch unit 23′″ is fully disengaged, the transmission ratio from the left axle shaft 20 to the left wheel shaft 21 is equal to the transmission ratio of a complete planetary gearset with a driven planet carrier and a fixed ring gear. The transmission ratio from input to output is given by R=1/(1+n_R/n_S), wherein n_R and n_S are the numbers of teeth for the ring and the sun gear, respectively. From n_R>n_S it follows further that R<0.5 and thus the wheel shaft 21 rotates at least twice as fast as the corresponding axle shaft 20. When, on the other hand, the yaw brake 60 is disengaged and the clutch of the combined brake and clutch unit 23′″ is fully engaged, the transmission ratio equals 1 and the wheel shaft 21 rotates with the same velocity as the axle shaft 20. By partially engaging the yaw brake 60 and the clutch, the transmission ratio can be varied continuously between R and 1. If, for example, the radius of the ring gear 56 is twice the radius of the sun gear 54, a transmission ratio from 1/3 to 1 can be provided. When the yaw brake 60 is engaged, a portion of the traction force is lost to the braking process. With the use of an electromagnetic brake as a yaw brake 60, the braking energy can be partially recuperated.

An electronic control unit is used to control the engagement of the yaw brakes. Thereby, the electronic control unit provides the functionality of torque vectoring and of a transverse differential. The electronic control unit determines via torque sensing means at the wheel shafts the amount of torque that is transmitted from the axle shafts to the wheel shafts. Furthermore, the electronic control unit evaluates information about the vehicle movement such as the steering angle to determine a current turning angle of the vehicle. Based on the torque signals of the torque sensing means and the vehicle movement data, the electronic control unit computes a desired torque transfer ratio between left and right wheel shaft. According to the desired torque transfer ratio the electronic control unit controls the degree of engagement of the yaw brakes and of the clutches of a left and the right combined brake and clutch unit 23′″.

According to another method, the electronic control unit does not determine a steering angle but it determines if a steering is taking place and no wheel is slipping and in this case controls the left and right yaw brakes and clutches of the left and right clutch and brake units to provide an equal torque at both sides. According to yet another method, an estimate of a road friction coefficient is used to determine, if a wheel is about to slip. In the aforementioned methods of controlling the engagement of the clutch and the yaw brake, the engagement of the yaw brake is a decreasing function of the engagement of the clutch, the yaw brake is always fully engaged when the clutch is fully disengaged and the clutch is always fully engaged when the yaw brake is fully disengaged. This is illustrated in FIG. 12.

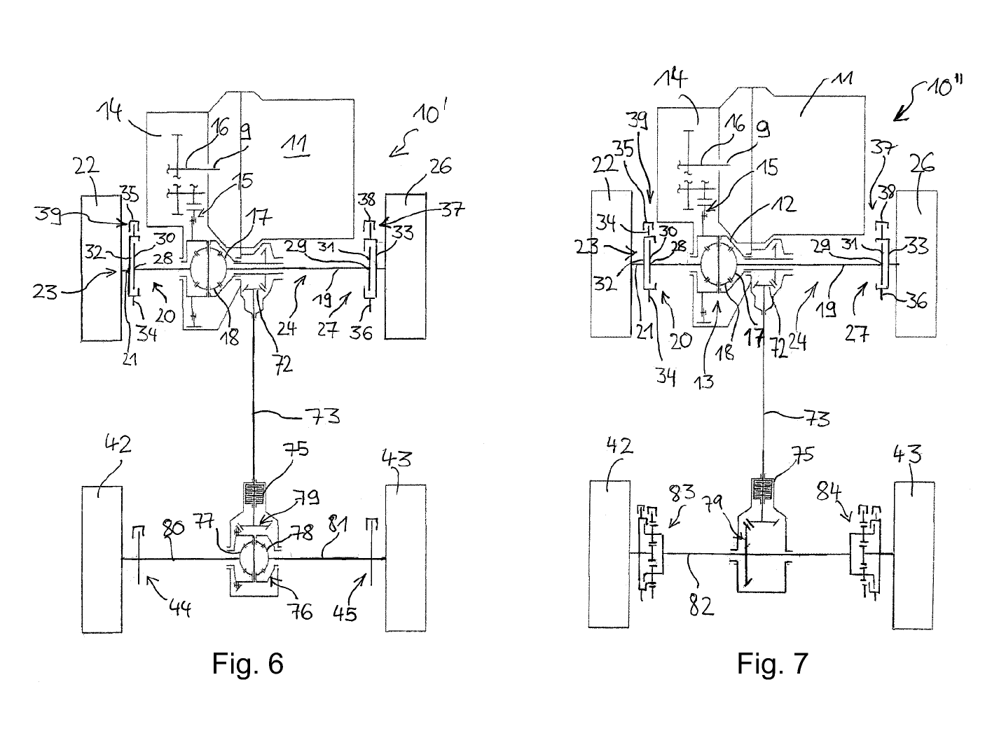

FIG. 6 shows a four wheel drive vehicle 10′, in which two combined brake and clutch units 23, 27 are provided at the two front wheels 22, 26 of the wheel drive vehicle 10′, as shown in FIG. 1. The particular four wheel drive shown in FIG. 6 is derived from a front wheel drive but a rear wheel drive derivative is equally possible. Side gears 17 of a front transverse differential 13 are connected to ring gears 18 and to a front axis 19 of the vehicle 10 in a known way. Furthermore, a carrier 12 of the differential 13 is connected to a pair of bevel gears 72 which is in turn connected to a propeller shaft 73. The propeller shaft 73 is connected to a multi-plate transfer clutch 75, which is provided for adjusting the torque ratio between front axis 19 and the rear axis. The multi-plate transfer clutch 75 is a torque sensing clutch, which is also commonly known as a ‘torsen clutch’.

Since the transmission 14 of the four wheel drive vehicle 10′ does not comprise a launch clutch, the torsion clutch 75 is used as a launch clutch for the rear wheels 42, 43. Therefore, the torsen clutch 75 is build more robust than a conventional torsen clutch 75, for example by use of more abrasion resistant materials such as clutch plates of ceramics or with ceramic surfaces. For use as launch clutches, the torsen clutch 75 and also the combined brake and clutch units 23, 27 at the front are actuated by hydraulic actuators, for example pistons, via hydraulic lines. In cars with a manual transmission, the hydraulic lines are in connection to the driver's clutch pedal whereas in cars with an automatic transmission the hydraulic lines are connected to a hydraulic control unit. The hydraulic lines are not shown in the figures. In alternative embodiments, pneumatic lines or actuators which have respective cable connections to a sensor at the coupling pedal may be used. The multi-plate transfer clutch 75 is connected to a rear transverse differential 76 via a set of bevel gears 79. Side gears 77, 78 of the rear differential 76 are connected to a left rear axle shaft 80 and a right rear axle shaft 81. A left disk brake 44 and a right disk brake 45 are provided at the left rear axle shaft 80 and the right rear axle shaft 81, respectively.

FIG. 7 to FIG. 9 show embodiments in which combined brake and clutch units are provided at the rear wheels to replace a rear transverse differential. However, they may equally well be used to replace a front transverse differential. When the combined brake and clutch units are used to replace a rear transverse differential, the torsen clutch does not need to be as strong as in the embodiment of FIG. 7, as the clutches of the combined brake and clutch units at the rear already serve as launch clutches.

FIG. 7 shows an alternative embodiment of a four wheel drive vehicle 10″ with combined brake and clutch units with yaw brakes according to FIG. 5 at the rear axle shafts. In contrast to the previous figure, the second bevel gear of the set of bevel gears is not connected to a casing of a rear transverse differential but is mounted on a rear axis. The rear axis is formed in one piece. It may also be realized as two interconnected axle shafts, though. A left combined brake and clutch unit with yaw brake according to FIG. 5 is provided at a left side of the rear axis and a right combined brake and clutch unit with yaw brake according to FIG. 5 is provided at a right side of the rear axis. Left and right torque sensing means are provided close to the left and right rear wheels 42, 43. The torque sensing means are connected to an electronic control unit. Outputs of the electronic control unit are connected to clutch actuators of the combined brake and clutch units 83, 84 and to the yaw brakes of the combined brake and clutch units 83, 84, respectively. The electronic control unit controls the clutches of the combined brake and clutch units 83, 84 to provide the function of a rear transverse differential.

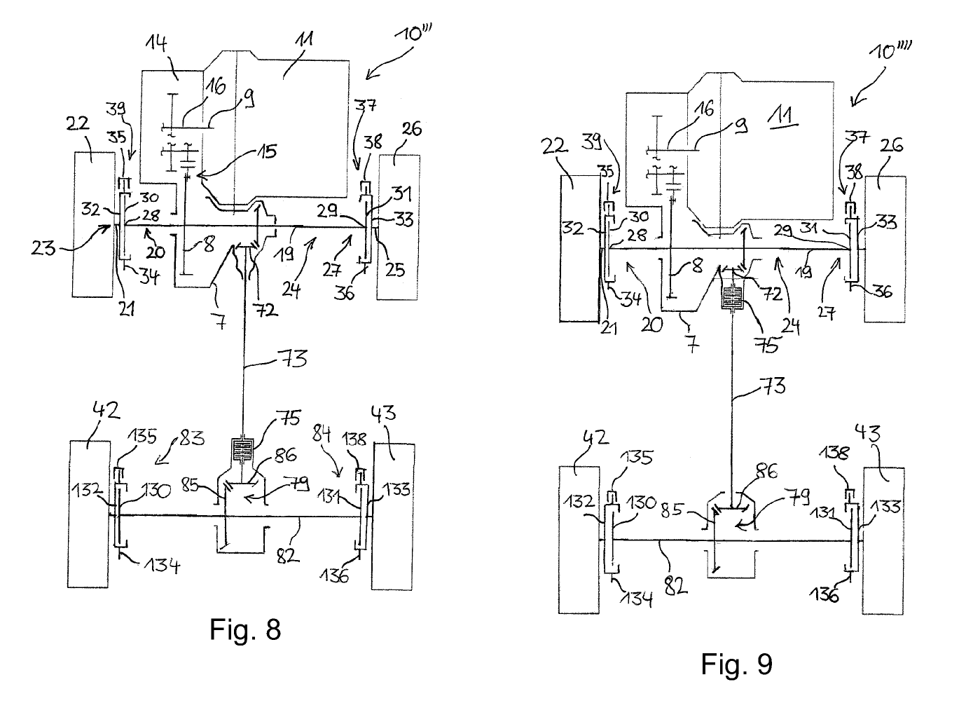

FIG. 8 shows another four wheel drive vehicle 10′″ in which the front transverse differential and the rear transverse differential are replaced by the combined brake and clutch unit shown in FIG. 2. The parts on the rear axis 82 are, from left to right, a rear left combined brake and clutch unit 83 with housing 132, brake caliper 135, brake ring 136, and clutch disk 130, a pair of bevel gears 79 with transverse bevel gear 85 and longitudinal bevel gear 86 and a rear right combined brake and clutch unit 84 with housing 133, brake caliper 138, brake ring 136, and clutch disk 131.

FIG. 9 shows another four wheel drive vehicle 10′″. In contrast to FIG. 8, the torsen clutch 75, which is used as interaxle differential is integrated into the gear casing 7 which covers the front gearwheel 8 and the bevel gears 72. As explained previously, the torsen clutch 75 must be built strong enough to take over the function of a launch clutch in order to transfer the acceleration force to the rear axis 82.

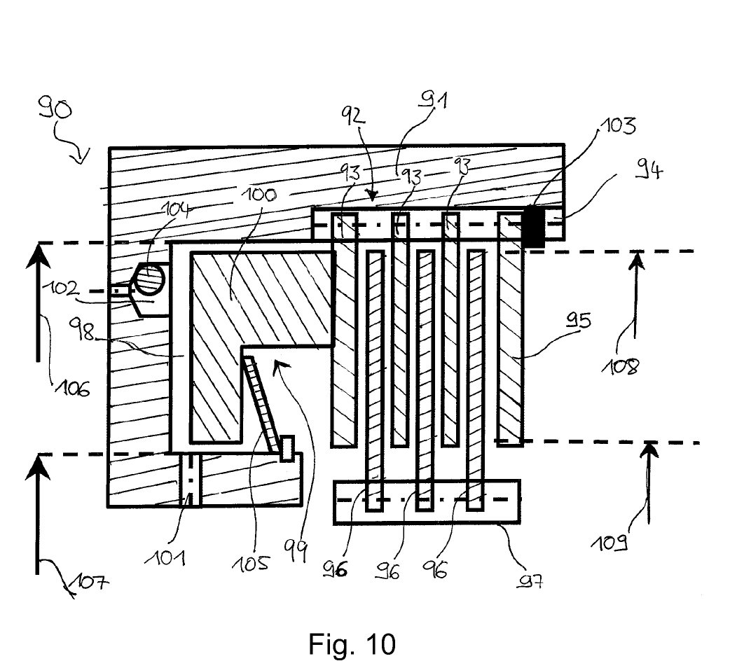

FIG. 10 shows a wet-type multiplate clutch 90 for use in a combined brake and clutch unit of the previous embodiments. A combined brake and clutch unit according to the invention has to support higher torque than a conventional launch clutch. In addition, it may also be used in a ‘sliding mode’ in which the clutch is not fully engaged. A multiplate clutch 90 as shown in FIG. 10 is especially useful in this context. It has multiple engaging surfaces for transmitting the torque and for discharging the generated heat. In a wet-type multiplate clutch the heat is also discharged through lubricating oil between the clutch plates. The multiplate clutch 90 comprises a piston carrier 91 which is connected to a first clutch pack 92 of outer disks 93. The outer disks 93 are provided at an outer disk carrier spline 94. A piston 100 is connected to the outer discs 93. Interleaving inner disks 96 are provided at an inner disc carrier spline 97. The disks 93, 96 are also known as clutch plates. The outer disk at the opposite site to piston 100 is known as end disk 95. The end disk 95 is fixed against lateral movement by a clip 103. The 91 piston carrier and the outer disks 93 are stationary with respect to rotation around the wheel shaft. The inner disks 96 and the inner disc carrier spline 97, on the other hand, rotate with the wheel shaft.

An inner space 98 of a hydraulic cylinder 99 is bounded by a piston 100 and the piston carrier 91. The inner space 98 is supplied with oil through an oil supply 101. An oil drain 102 is provided at a bottom of the inner space 98 to take up excess oil. The oil drain 102 comprises a cavity with a valve ball 104. Preferably, the multiplate clutch 90 is oriented such that the oil supply 101 and the oil drain 102 are located on the inner side, towards the vehicle. A cup spring 105 is provided between the piston carrier 91 and an outer side of the piston for returning the multiplate clutch 90 to a disengaged position. A lateral height of a chamber, in which the piston 100 is moving, is indicated by an outer distance 106 and an inner distance 107. A lateral distance over which the inner disks 96 and the outer disks 93 overlap is indicated by a second outer distance 108 and a second inner distance 109. The distances 106, 107, 108, 109 are measured from the axis of a wheel shaft.

The multiplate clutch 90 of FIG. 10 is shown as a naturally open clutch, which is pushed open by the cup spring 105 if no oil pressure is applied to the piston 100. The arrangement of the oil chamber 98 and the cup spring 105 may also be reversed. In the reversed arrangement, the oil pressure and the force of the cup spring 105 act in the opposite direction relative to the arrangement of FIG. 10. Both arrangements can be build as naturally open and as naturally closed clutch and may be used in a combined clutch and brake unit 23, 23′, 23″, 23′″ according to the previous figures. A clutch according to FIG. 10 which is specially reinforced may also be used as launch clutch for the rear wheels in the embodiment of FIG. 7. To this end, the carrier splines 94 and 97 are connected to an input shaft and an output shaft, respectively. To provide the function of an interaxle differential a modified version of this clutch which is known as ‘Haldex® clutch’ may be used. In the Haldex® clutch, a swash plate controls the oil pressure that acts upon the piston 100. When a slip occurs between the clutch disks of the carrier spline 94 and 97, the swash plate turns and thereby a hydraulic piston pump is actuated and the pressure on the piston 100 is increased. The pressure and thus the torque distribution between front and rear axle may be further regulated by an electronically controlled throttle valve and/or an electronically controlled piston pump. The means to generate the hydraulic pressure are not shown in FIG. 10. For use as a launch clutch for the rear wheels of a four wheel drive vehicle, a differential lock may be activated to disable the torque sensing mechanism. For example, an electronic control may override the torque sensing mechanism of an electronically controlled clutch and control the clutch to be fully engaged by opening the throttle valve and/or applying maximum pressure via the hydraulic pump. The same functionality can also be provided by a mechanical mechanism which is actuated when a clutch pedal is released to start the car.

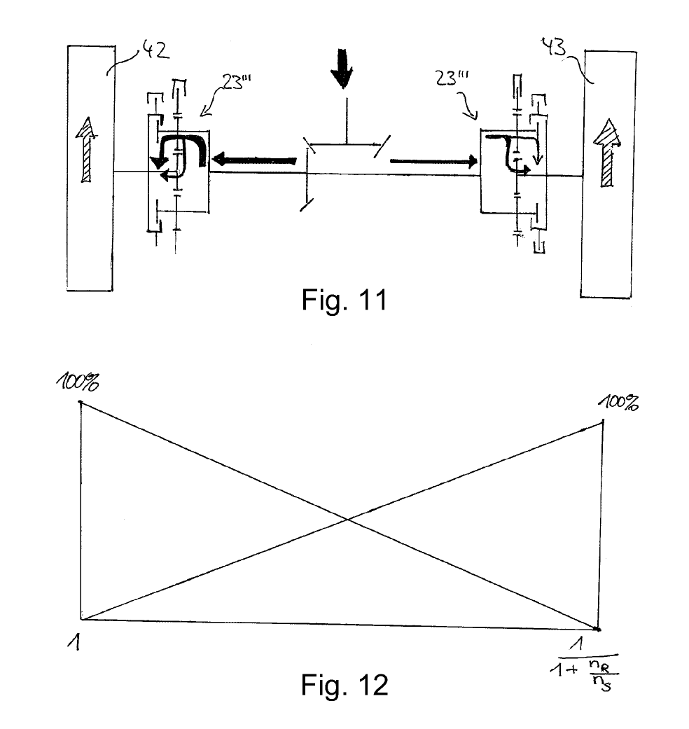

FIG. 11 shows a configuration in which two combined brake and clutch units according to FIG. 5 are provided at the rear of a vehicle to substitute a rear transverse differential. The right and left brake and clutch units 23′″ are identical in construction, so the same reference number is used. A situation is shown in which the vehicle is steering to the left. The right yaw brake 60 is partially engaged and the right clutch is partially released to accelerate the outer wheel 43 on the right. Therefore, the overall torque flow to the right side is decreased and the torque flow through the sun gear is increased relative to the torque flow through the housing. On the left side, the clutch is engaged and the yaw brake 60 disengaged. Therefore, only a small torque flow goes through the sun gear, the planet carrier rotates with the sun gear and the left wheel 42 is not accelerated relative to the left rear axle shaft.

In the vehicles of FIG. 6 and FIG. 7, CV joints are provided at the ends of the propeller shaft 73, on the outer sides of the rear transverse differential 76 and at the inner sides of the brakes 44, 45 and of the brake and clutch units 83, 84. These CV joints connect shafts which are oriented at different angles and are not shown in FIGS. 6 and 7, for simplicity.

FIG. 12 shows the degree of engagement of the clutch and the yaw brake over the transmission ratio. “Degree of engagement” in this context means the ratio of the actual torque transfer to the highest achievable torque transfer at full engagement. The dependence to the applied force, which can be controlled by the electronic control unit, is in general nonlinear and changes with wear and tear. It can be accounted for by closed loop control with torque measurement and/or calibration. At a transmission ratio of 1, the clutch is engaged to 100% and the yaw brake is disengaged. At a transmission ratio of 1:(1+n_R/n_S), on the other hand, the yaw brake 60 is engaged to 100% and the clutch of the combined brake and clutch unit 23′″ is disengaged. These situations correspond to the left and right side of FIG. 12, respectively.

The combined brake and clutch unit according to the application can be used to replace a launch clutch or torque converter in a motor-transmission unit of a car. This is possible for cars that have a combustion engine but also for cars that have a hybrid drive and a friction based launch device such as mild hybrid cars and that use a combustion engine and an electric engine for launching the car. The combined brake and clutch unit makes it possible to build the motor-transmission unit more compact and service-friendly. Furthermore, a transverse differential can be replaced by electronically controlled combined brake and clutch units according to the application. Despite the additional clutches bringing in extra weight and some frictional losses, there are savings in cost, weight and packaging space with respect to a differential gear. This is also an important aspect for hybrid vehicles which need to be lightweight and small. Moreover, by using combined brake and clutch units with yaw brakes, the frictional losses in comparison to a differential can be reduced considerably.

Further variations to the abovementioned embodiments are possible. For example, in the combined brake and clutch units drum brakes may be used instead of disk brakes. Although the combined brake and clutch and brake units are shown with single brake rings and a single clutch surfaces they may be realized in different manners. The clutches as well as the brakes may also be realized as multiplate design and they may have air-cooling as well as oil based cooling.

To provide the function of a park-lock, at least two of the brakes of a vehicle may be provided with a lock function, such that the car is still blocked, even if the brakes or the pressure supply to the brakes fail. The park-lock provides additional security against theft, similar to a wheel clamp. Alternatively, at least two of the clutches of the brake and clutch units may be provided with a lock function.

To avoid that a residual torque is transmitted to the wheel shafts when the vehicle is standing and the motor is idling, a brake of the respective brake and clutch unit may be engaged slightly. A further mechanism may be provided that opens the clutch of a combined brake and clutch unit when the vehicle is standing or when the engine revolution speed drops below a predefined revolution speed to avoid stalling the engine 11.

In connection with a closed loop control, the combined brake and clutch unit can be used to support an antilock braking system (ABS) or an electronic stability program (ESP) by controlling the combined brake and clutch units. An ESP may be further improved by providing a yaw brake as shown in FIG. 5. A closed loop control which uses a torque sensing means at the wheel shafts can furthermore compensate for wear and tear of the friction linings and alert the driver when either the brake pads or the clutch plate needs to exchanged.

The electronically controlled yaw brake corrects undesired effects such as oversteer and understeer by providing an additional steering mechanism. The embodiment of FIG. 5 is a modular solution in that the parts of FIG. 5 can be fitted to an existing drivetrain with an existing differential.

Combined brake and clutch units can replace the function of a conventional transverse differential or a limited slip differential, as shown in FIG. 1, FIG. 6, FIG. 7, FIG. 8, FIG. 9, and FIG. 11. A torque sensing limited slip differential can be realized with torque sensing means at the wheels, a revolution speed sensing limited slip differential can be realized with wheel revolution speed sensing means and a combination of both can be realized by using torque sensing means and wheel revolution speed sensing means together. A differential lock is particularly easy to realize by engaging the right and left clutch.

The yaw brake of FIG. 5 provides a better control of the transferred torque and the revolution speed. Although an electronically controlled combined brake and clutch unit without yaw brake can be used to provide differential and active yaw functionality, the yaw brake allows a better control of the transferred torque and the wheel revolution speed. Whereas the clutch of a combined brake and clutch unit according to the application is used to reduce the wheel revolution speed of the adjacent wheel, the yaw brake according to the application is used to accelerate the revolution speed of an adjacent wheel, wherein “adjacent” means next to the combined brake and clutch unit.

The electronic control can furthermore evaluate the movement of the vehicle and keep the vehicle controllable even in situation where a mechanical differential would fail.

The active yaw functionality provided by the embodiment of FIG. 5 is a relatively economic solution. No complicated parts, such as additional differentials for each wheel, are needed. Thus, the added security of an active yaw control can be provided not only for luxury cars but also for mid-size cars.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practice. Thus, the scope of the embodiments should be determined by the claims and their equivalents, rather than by the examples given. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A combined brake and clutch unit for a drivetrain of a vehicle having an axis and a wheel axis, comprising:
a brake actuator;
a clutch having a surface connected to the axis;
a housing of the clutch connected to the wheel axis and the surface; and
a brake ring at the housing of the clutch and enclosed by the brake actuator

2. The combined brake and clutch unit according to claim 1, further comprising an incomplete planetary gearset.

3. The combined brake and clutch unit according to claim 1, further comprising a complete planetary gearset having a ring gear and the surface is formed as a clutch ring at the ring gear of the complete planetary gearset.

4. The combined brake and clutch unit according to claim 1, further comprising a complete planetary gearset having a ring gear and the brake ring of a yaw brake at the ring gear of the complete planetary gearset.

5. The combined brake and clutch unit according to claim 1, further comprising an electronic control unit connected to a clutch actuator of the clutch.

6. The combined brake and clutch unit according to claim 4, further comprising an electronic control unit connected to the brake actuator of the yaw brake.

7. A method of operating an arrangement of a combined brake and clutch unit of a vehicle comprising two wheels, comprising the steps of:
measuring a torque at each of the two wheels;
calculating degrees of engagement of a clutch of the combined brake and clutch unit with an electronic control unit such that the torque at the two wheels is essentially equal;
applying a clutch actuator of the combined brake and clutch units according to the degrees of engagement.

8. The method according to claim 7, further comprising the steps of:
deriving a motion of the vehicle from sensor data;
calculating an engagement of a yaw brake;
actuating a brake actuator of the yaw brake according to the degrees of engagement.

9. A vehicle, comprising
an axis;
a wheel axis;
A drivetrain; and
A combined brake and clutch unit for the drivetrain, comprising:
a brake actuator;
a clutch having a surface connected to the axis;
a housing of the clutch connected to the wheel axis and the surface; and
a brake ring at the housing of a clutch and enclosed by the brake actuator.

10. The vehicle according to claim 9, further comprising an incomplete planetary gearset.

11. The vehicle according to claim 9, further comprising a complete planetary gearset having a ring gear and the surface is formed as a clutch ring at the ring gear of the complete planetary gearset.

12. The vehicle according to claim 9, further comprising a complete planetary gearset having a ring gear and the brake ring of a yaw brake at the ring gear of the complete planetary gearset.

13. The vehicle according to claim 9, further comprising an electronic control unit connected to a clutch actuator of the clutch.

14. The vehicle according to claim 12, further comprising an electronic control unit connected to the brake actuator of the yaw brake.

15. A computer readable medium embodying a computer program product, said computer program product comprising:
a program for operating an arrangement of a combined brake and clutch unit of a vehicle comprising two wheels, the program configured to:
measure a torque at each of the two wheels;
calculate degrees of engagement of a clutch of the combined brake and clutch unit with an electronic control unit such that the torque at the two wheels is essentially equal;
apply a clutch actuator of the combined brake and clutch units according to the degrees of engagement.

16. The computer readable medium embodying the computer program product according to claim 15, the program further configured to:
derive a motion of the vehicle from sensor data;
calculate an engagement of a yaw brake;
actuate a brake actuator of the yaw brake according to the degrees of engagement.
